(19) United States
(12) Patent Application Publication
(10) Pub. No.: US 2016/0302445 A1
(43) Pub. Date: Oct. 20, 2016

(54) Processing method to convert oily sticky byproducts into dry products with animal blood

(71) Applicant: John Lee, Olathe, KS (US)

(72) Inventor: John Lee, Olathe, KS (US)

(73) Assignee: RIGEL TECHNOLOGY CORPORATION, Olathe, KS (US)

(21) Appl. No.: 14/690,118

(22) Filed: Apr. 17, 2015

(51) Int. Cl. A23K 1/04

(52) U.S. Cl. CPC A23K 1/04; A23K 1/1813; A23K 1/001

(57) ABSTRACT

A processing method to convert oily sticky food byproducts into non-oily and non-sticky dry products by using liquid animal blood is provided. Moisture in the food byproducts is reduced for reducing drying cost and pH is adjusted to 4-10 with preferred range at 6-8, then liquid animal blood is mixed, heated to above 65° C. for coagulation to form non-oily and non-sticky wet products after removing free water. Then related drying equipment is used to produce the non-oily and non-sticky dry products. The non-oily and non-sticky dry products are in particle or fine form with good flowability. The dry products are easy to be stored, transported and applied, which are used in food and feed industries. Besides general feed applications, the non-oily and non-sticky dry products have bypass function for ruminants.

### REFERENCE CITED

### U.S. Patent Documents

| | | | |
|---|---|---|---|
| 8,895,689 | Nov. 25, 2014 | Melnyk, et al. | 528/295.5 |
| 8,864,868 | Oct. 21, 2014 | Burnham | 71/11 |
| 8,677,647 | Mar. 25, 2014 | Weisselberg | 34/167 |
| 8,197,680 | Jun. 12, 2012 | Sharir | 210/108 |
| 8,003,833 | Aug. 23, 2011 | Appel, et al. | 585/240 |
| 7,446,215 | Nov. 4, 2008 | Lee | 554/156 |
| 6,805,897 | Oct. 19, 2004 | Rounds, et al. | 426/623 |
| 6,464,875 | Oct. 15, 2002 | Woodruff | 210/603 |
| 6,368,657 | Apr. 9, 2002 | Lee | 426/658 |
| 6,235,339 | May 22, 2001 | Harmon, et al. | 426/646 |
| 6,229,031 | May 8, 2001 | Strohmaier, et al. | 554/156 |
| 5,958,241 | Sept. 28, 1999 | DeBenedetto, et al. | 210/611 |
| 5,514,388 | May 7, 1996 | Rohwer | 426/231 |
| 5,496,572 | Mar. 5, 1996 | Rudden | 426/74 |
| 4,217,370 | Aug. 12, 1980 | Rawlings, et al. | 426/98 |
| 4,216,234 | Aug. 5, 1980 | Rawlings, et al. | 426/2 |
| 4,138,505 | Feb. 6, 1979 | Hart, et al. | 426/573 |

### Foreign Patent Documents

| | | |
|---|---|---|
| NZ 630339 | Mar. 25, 2015 | Lee, et al. |
| WO 2007012129 A1 | Feb. 1, 2007 | Max |
| NZ 504619 | Oct. 6, 2003 | Degremont |

### FIELD OF THE INVENTION

The present invention relates to the processing method to convert oily sticky food byproducts into non-oily and non-sticky dry products by using animal blood to encapsulate oily or/and sticky food byproducts into non-oily and non-sticky wet products and reducing moisture for reducing drying cost. Then related drying equipment is used to remove moisture from the non-oily and non-sticky wet products into the dry products, which are in particle or fine form with good flowability and easy to be stored, transported and applied. The dry products may be used for feed and food industries. Besides general feed applications, the non-oily and non-sticky dry products have bypass function for ruminants.

### BACKGROUND OF THE INVENTION

During food processes, many food byproducts special oily, sticky or oily and sticky byproducts are produced commonly. It is very difficult to process oily sticky food byproducts into dry products effectively. For examples free fatty acid material in food-grade oils is removed by a base, heat and centrifuging processes. Its byproduct (soap stock) is produced with oily and sticky properties. The soap stock byproduct also has moisture, which becomes rancid with some smell over time. After heating or adding an acid, its viscosity is reduced and moisture may be removed by heat and centrifugation or setting processes. Its viscosity is increased again when temperature is cooled down to room temperature. In the pre-treatment during biodiesel production, oily soap stock is also produced. Soap stock, which usually has free fatty acid level at 20-80% on fat basis, may be used as feed-grade oily ingredient. Many food processes need to use large-volume water and produce wastewater. Different food byproducts are left in the wastewater. Wastewater is usually transferred into a pond or lagoon. Grease is lighter than water, which floats to the top to form a layer of oily byproduct, which may be processed into brown grease. There are also other food byproducts with heavy gravity than water or almost the same as water, which sink to the bottom or float in water. Some coagulated agent (such as AlCl3 or polymer) is used to help to form strong coagulation with food byproducts to sink to the bottom or float to the top.

A dissolved air flotation (DAF) unit is major equipment, which is used to treat wastewater. Oily food byproducts float to the top of wastewater in sludge form and then separated from water by mechanical skimming, which may be processed into liquid brown grease and wet solid products by heat and centrifugation processes. The brown grease is used as a low-value fat product. The wet solid product is dried into a dry feed product. Another way is to use grease and heat to remove moisture. Then centrifugation or pressing process is used to separate into its solid product and brown grease. The DAF solid product is usually very oily and fine. A non-oily ingredient such as soybean or corn meal is often mixed with the oily DAF solid product at low rate such as 75:25 to reduce its oily property. Oily wastewater sludge usually contains fat, protein, moisture and other organic and inorganic materials. DAF grease (brown grease) contains free fatty acids at 20-80% on fat basis. After removing the oily sludge, wastewater treatment cost with biological method is reduced. Food byproducts either float or sink in wastewater are usually oily and sticky, which also has moisture. They become rancid easily with some smell over time. Food byproducts from wastewater treatment contain fat, protein, moisture and others. Their fat, protein and other nutrients may be used as nutritional ingredients for feed applications.

Some high-value products such as gelatin from animal skin and bone materials or water-soluble protein from soybean are extracted and produced for different human applications. Food byproducts are commonly concentrated with oily, sticky or oily and sticky properties. For these oily sticky food byproducts, heat process is used for reducing viscosity and moisture. But it is very difficult to process these oily sticky food byproducts into dry products because of the oily and sticky properties. Another example is liquid molasses, which is a byproduct during sugar production. Molasses has sweet taste and sticky property. Its viscosity is reduced with a heat process and increased again when temperature is cooled down. When molasses is transferred from one location to another location, it needs to be kept in warm temperature, which costs energy. When molasses is viscous, it is hard to be pumped because of its high viscosity. Molasses, which is usually from cane or beet sugar production, may be used for food or feed applications.

If oily sticky food byproducts are not processed properly on time, they may cause problems and pollution issues to water, land and air. We need to consider both of public health and economical achievements. Non-oily and non-sticky dry products are preferred, which are particle or fine form with good flowability and easy to be stored, transported and applied for different applications.

Over the years, various attempts have been made to process oil sticky food byproducts. A number of patents have been issued for these attempts. NZ (New Zealand) Patent No. 630339 (2015) discloses a processing method to mix DAF sludge with calcium hydroxide and particle material and dry into a dry product in particle form with a hot air dryer by the author and his NZ coworker. U.S. Pat. No. 8,895,689 (2014) discloses a process for producing an alkyd resin by reacting waste cooking oil, one or more aromatic polycarboxylic acids, aliphatic polycarboxylic acids, or esterified polymerization products, and one or more polyols. U.S. Pat. No. 8,864,868 (2014) discloses a method for treating organic-containing sludges and converting such sludges to fertilizers. U.S. Pat. No. 8,677,647 (2014) discloses the apparatus and method for processing sewage sludge to produce a dried sludge product. U.S. Pat. No. 8,197,680 (2012) discloses the apparatus for wastewater sludge dewatering apparatus includes an inflatable membrane to press solids against a screen and thereby separate liquid and nozzles to wash the screen of the separated solids. U.S. Pat. No. 8,003,833 (2011) discloses a process to convert organic, waste or low-value materials into useable products including gas, oil and carbon solids with high heat and pressure. High heat and high pressure mean high cost.

U.S. Pat. No. 7,446,215 (2008) discloses a method for preparing a solid fat product from waste liquid fat or oil ingredients by heating to above 85° C. and mixing lime to react with the fat to form fatty acid salts and cooled down to below 45° C. to form the solid fat product in dry form by the author. WO 2007/012129 (2007) discloses a method of producing a product comprising a mixture of a grain material and DAF sludge, which is extruded under high temperature and pressure and at a pH of at least 6.2. U.S. Pat. No. 6,805,897 (2004) discloses a process to produce a feed supplement comprising DAF and paunch manure and an inert dry medium through the extrusion process. NZ Patent No. 504619 (2003) discloses a method for regulating centrifuges for dehydrating wastewater sludge, using fuzzy logic. U.S. Pat. No. 6,464,875 (2002) discloses a system and method for converting animal, vegetable and food byproduct materials into useful bio-gas and fertilizer using anaerobic digestion. U.S. Pat. No. 6,368,657 (2002) discloses a process for precipitating DAF skimming sludge into a non-oily nutritional product with protein and fat by the author. The material is limited to DAF skimming sludge only and also dewater process is not investigated, which need to be improved. U.S. Pat. No. 6,235,339 (2001) discloses a process method to treat the meat processing waste stream with some chemicals. U.S. Pat. No. 6,229,031 (2001) discloses a method for preparing fatty acid oil into a calcium salt product with calcium oxide. The calcium soap salt products have the bypass function for ruminant animals.

U.S. Pat. No. 5,958,241 (1999) discloses the waste treatment and minimization system including a bioreactor and a liquid/solid separator for treatment of organic plant wastes and associated waste water treatment processes. U.S. Pat. No. 5,514,388 (1996) discloses a process to treat protein with a base to increase the pH to such as 11 at first. Then the fat is added into the alkali protein. The protein firm gel is formed when the pH is lowed to 3 to 5. There is high ash in the final product because more base and acid are used. U.S. Pat. No. 5,496,572 (1996) discloses a process to form a ruminant feed stuff by a homogeneous mixture of animal or vegetable protein material, one or more fatty acids, and a calcium or magnesium compound by an extrusion process. U.S. Pat. No. 4,217,370 (1980) discloses a process to treat protein with a base to increase the pH to such as 11. Then the fat is added into the alkali protein. The protein and fat are mixed together before any pH change. The protein gel is formed when the pH is lowed to the isoelectric point. U.S. Pat. No. 4,216,234 (1980) discloses a process to render albumin medium with strongly alkaline such as 11.5 prior to the formation of the fat dispersion or emulsion, and thereafter the dispersion or emulsion is heated to form a gel. U.S. Pat. No. 4,138,505 (1979) discloses a process to heat animal blood to a temperature in the range of from about 20° C. to 60° C., to adjust the pH of the heated aqueous medium to a level ranging from 9 to about 13 to form a blood solid gel, and thereafter recovering the fat-protein gel.

### SUMMARY OF THE INVENTION

The present invention overcomes the problems of other patents. Its purpose is to convert oily, sticky or oily and sticky food byproducts into non-oily and non-sticky products. Free water is removed before a drying process, which reduces drying cost. The dry products are in particle or fine form. The processing method in this invention provides an efficient processing method for food and feed industries.

It has been found that liquid animal blood can be used to encapsulate and convert oily, sticky or oily and sticky food byproducts at above 65° C. into non-oily and non-sticky products in wet form after heating and coagulating their mixture. The mixing rates of animal blood and food byproduct are at from 10:90 to 90:10 with preferred range at from 20:80 to 50:50 on solid basis. Most food byproducts may have wide moisture range without free water generally. It is easy to remove free water by filtration or screen process. The improved wet products after this process contain produced free water because of the coagulation process. Then produced free water can be removed by screen, filtration, press, centrifugation or their combination mechanically for reducing drying cost. Then related drying equipment is used to remove moisture into non-oily and non-sticky dry products in solid form, which may be in particle or fine form. Free water may be released into a wastewater pond or into wastewater stream. When raw materials from food byproducts have very low moisture (such as brown grease or concentrated molasses), then formed wet products may have no or almost no free water. When the coagulated wet products have less than 65% moisture (or above 35% solids) and preferred less than 55% moisture (or above 45% solids), free water is usually not shown up.

It also has been found that after liquid animal blood is used to encapsulate and coagulate food byproducts at above 65° C., the process helps the protein, fat and other contents in food byproducts to have bypass function to ruminants besides animal blood protein as bypass protein. For example liquid brown grease has no bypass function. After mixing with animal blood, coagulation and drying processes, their product in particle form has bypass fat about 70%. Brown grease in solid particle form in the dry product can be used as a bypass fat product for dairy animals. Other examples are to use liquid animal blood to encapsulate and coagulate food byproducts or some feed ingredients (wet or dry form) onto their surface such as soybean meal, soybean protein derivatives, wheat, wheat straw wheat bran, corn meal, corn stalks, corn cobs, alfalfa, sweet bran, silage, oats, oat straw, barley, barley straw, meat meal, meat/bone meal, DAF solid product (wet or dry form), inorganic salts, vitamin products, maize meal, maize derivatives, sunflower meal, cottonseed meal, feed ingredients or mixtures thereof. Their mixing rates of animal blood and feed ingredients (food byproducts or feed products) are at from 5:95 to 50:50 with preferred range at from 10:90 to 30:70 on solid basis. For example liquid poultry blood is mixed with the oily DAF solid product at high rate such as 15:85 on solid basis to make a non-oily product with protein and fat instead of mixing soybean meal with the oily DAF solid product at low rates such as 75:25 on solid basis for reducing the oily property of the DAF solid product. Animal blood is coated and coagulated onto feed ingredient surface, which provides a protection layer for feed ingredients to have bypass function for ruminants.

Before mixing one or mixed food byproducts with liquid animal blood (including animal blood after removing plasma), it is good to remove free water from food byproducts with screen, filtration, press or centrifugation mechanically at reasonable cost for reducing drying cost. A presser with one or two screws is the most common equipment for different dewatering applications at low cost. Its screen sizes in a presser are often at 0.2-2 mm holes, which are still not small enough for many applications such as sludge materials from food, feed and other industries in soft form, which is easy to pass through these holes. When cloth and screen are used together, cloth holes are much small. Strong and heavy cloth is preferred for long-term usage. The screen is usually made with metal or plastic materials. It is at low cost for mechanical dewater from general sludge materials for different industries. Additional supporter may provide more strong support to the cloth during pressing process. Before pressing process, oily property of oily sludge materials may be reduced by pH adjustment, adding lime or other methods. Liquid oil or grease with more moisture may be heated and set or centrifuged with a liquid-liquid centrifuge for removing moisture. Oily sludge materials may also be heated and set or centrifuged for removing moisture.

Oily, sticky or oily and sticky food byproducts contain wide-range moisture with 2-95% on weight basis. Raw soap stock such as soybean or corn oil soap stock has moisture at 50-80%, which may be reduced to 2-60% by heating and setting or centrifugation processes. Liquid oil product after its process usually has low moisture at 2-10%. Oily sludge from wastewater treatments (pond or DAF) has moisture at 65-95%, which may be reduced to 2-10% by heating and setting or centrifugation processes. Dried DAF solid product, which often is oily, may have low moisture such as 2-15%. Molasses, which can provide sweet taste, may have moisture at 20-60% after heating and concentration processes. Liquid animal blood may have moisture at 80-90%. Liquid poultry blood usually has about 10% solids and pork or beef blood usually has about 10-18% solids, which includes some water used for washing purposed during collecting animal blood. After plasma is removed from liquid pork or beef blood, the left animal blood (red blood cells) may have moisture at 70-85%. Moisture in liquid animal blood is usually difficult to be reduced mechanically and economically. Plasma with light color is a small part in animal blood. Animal blood products may be used in feed or food applications, which depend on raw materials, environment and processing situations.

For the process in this invention for converting oily, sticky or oily and sticky food byproducts into non-oily and non-sticky dry products, liquid animal blood is mixed with oily, sticky or oily and sticky food byproducts at from 10:90 to 90:10 (preferred range at from 20:80 to 50:50) on solid basis at pH at 4-10. Then the mixture is heated to above 65° C. to coagulate into a wet product, which usually produces free water. A press or centrifugation process is used to remove free water mechanically and economically. The wet product is usually in wet particle form, which has no oily and sticky properties. The particles have more surface areas for moisture to be evaporated practically. Then related drying equipment is used to dry the wet product into a dry product, which has good flowability without oily and sticky properties.

Many food byproducts may have oily, sticky or oily and sticky three situations. Liquid animal blood usually has pH around 7. Food byproducts usually also have pH around 7, which is within 4-10 range and do not need to be adjusted. Their mixtures at pH 6-8 produce strong coagulation products. Before their coagulation, liquid animal blood is mixed with food byproducts with non-free water form. After their coagulation with heat, a wet coagulated product in particle form and free water are produced. Then the free water can be removed mechanically and economically by screen, press, filtration, centrifugation or their combination. Heat is applied directly, indirectly or combination by steam or/and cooking methods. Drying cost is reduced significantly after removing free water. Wet particle products have more surface areas, which help to evaporate moisture easily and reduce drying cost. Oil products such as brown grease or soybean soap stock oil have very low moisture, which can be stored for long term. When brown grease or soap stock oil is mixed with liquid animal blood (special for moisture at 70-85%), a coagulated wet product may have less or almost no free water produced because of their high solid levels, in which it is not necessary to need a process to remove moisture because of no free water. Drying equipment and drying process are two major costs. Its drying cost is reduced by removing moisture as possible from coagulated wet products. Dry products usually have less 12% moisture, which can be stored long term, are used in feed and food industries.

For mixing oily food byproducts with liquid animal blood before coagulation, uniform by mixing is important for better encapsulation. Oily materials are normally hydrophobic and not water soluble. When mixture is mixed well, oily materials and liquid animal blood may form uniform products after coagulation. When oily food byproducts have free fatty acids, their encapsulation may be better. Free fatty acids (RCOO—) have hydrophilic groups besides hydrophobic groups. The hydrophilic groups help to be more soluble in liquid animal blood. Normal feed-grade grease or oil has free fatty acid level below 5%. Normal food-grade oil or grease has free fatty acid level below 0.5%.

During the process in this invention, small amount of a deodorization, peroxide, oxidization or decontamination agent may be used to reduce smell issue from food byproducts and animal blood. Small amount of hydrogen peroxide may be reacted to not increase ash level in these final dry products. These chemicals may also reduce product color. For dry products, small amount of flowable agent such as corn meal powder or calcium carbonate powder at 0.2-5% may be mixed to increase flowability of these final dry products. Dry encapsulated products contain protein, fat and other contents, which are used for feed and food applications. The products may also have bypass function for ruminants, which helps dairy animals to produce more milk because of the bypass function. After the process in this invention, dry encapsulated products have non-oily and non-sticky properties in dry particle or fine form. Dry products are easy to be stored, transported and applied.

### DETAIL DESCRIPTION OF THE PREFERRED EMBODIMENTS

The following examples set forth preferred methods in accordance with the invention. It is to be understood, however, that these examples are provided by way of illustration and nothing therein should be taken as a limitation upon the overall scope of the invention.

### EXAMPLE 1

Liquid beef blood (250 grams after removing plasma) and oily sticky DAF sludge (250 grams) were mixed well. The mixture was mixed and heated to about 90° C. to form coagulation. A wet product and free water were produced. Free water was pressed and removed through metal screen. The non-oily and non-sticky wet product was heated to about 100° C. and dried into a dry product in particle form. The product contained protein (59.1%), fat (23.7%), moisture (8.3%) and ash (2.7%). The dry product was non-oily and non-sticky.

### EXAMPLE 2

Vegetable oil soap stock (25 grams), stick molasses (25 grams) and liquid pork blood (250 grams after removing plasma) were mixed well. The mixture was mixed and heated to about 85° C. to form coagulation. The wet product was heated to about 100° C. and dried into a dry product in small particle form. The product contained protein (46.6%), fat (22.4%), moisture (5.3%) and ash (7.5%). The dry particle product was non-oily and non-sticky.

### EXAMPLE 3

Soybean meal in fine/particle form (100 grams) and liquid poultry blood (100 grams) were mixed well. The soybean meal contained protein (47.9%) and moisture (6.6%). A small nylon bag with the soybean meal was placed in dairy fluid. Its bypass protein was 21.2% on protein basis. Their mixture was wet, which was stirred and heated to about 100° C. and dried into a dry product in small particle and free flowing form. The dry product contained protein (52.4%) and moisture (3.8%). A small nylon bag with the dry product was placed in dairy fluid. Its bypass protein was 61.2% on protein basis. After the process, the bypass protein was increased from 21.2% to 61.2% on protein basis.

### EXAMPLE 4

Liquid poultry blood (100 grams) and oily/sticky DAF solid product in fine form (100 grams) were mixed. The oily DAF solid product contained fat (43.8%), protein (36.3%) and moisture (5.9%), which is not free flowing. Their mixture was wet, which was stirred and heated to about 90° C. Additional liquid poultry blood (80 grams) was mixed. The wet product was stirred and heated to about 100° C. and dried into a dry product in small particle and free flowing form. The dry product was non-oily and non-sticky, which contained fat (35.7%), protein (44.4%) and moisture (3.9%). A small nylon bag with the dry product was placed in dairy fluid. Its bypass fat was 81.8% on fat basis and bypass protein was 91.9% on protein basis.

### EXAMPLE 5

Liquid poultry blood (650 grams) and brown grease (40 grams) processed from poultry wastewater lagoon were mixed well. The mixture was mixed and heated to about 90° C. to form coagulation. A wet product and free water were produced. Free water was removed with metal screen. The non-oily and non-sticky wet product was heated to about 100° C. and dried into a dry product in particle form. The product contained protein (58.2%), fat (29.8%), moisture (7.5%) and ash (3.4%). The dry particle product was non-oily and non-sticky. A small nylon bag with the dry product was placed in dairy fluid. Its bypass fat was 69.7% on fat basis and bypass protein was 96.2% on protein basis.

What is claimed is:

1. A method of preparing a non-oily and non-sticky dry product comprising increasing solid level to more than 10% on weight basis for an oily sticky food byproduct, adjusting pH to 4-10 with preferred range at 6-8, mixing with liquid animal blood, heating to above 65° C. for coagulation, increasing solid level to more than 25% on weight basis to form the non-oily and non-sticky wet product, and using a drying equipment to dry the wet product into the non-oily and non-sticky dry product.

2. The method of claim 1 wherein the food byproduct is from food, feed and industrial processes with oily, sticky or oily and sticky properties.

3. The method of claim 1 wherein the liquid animal blood is from whole animal blood or after removing plasma.

4. The method of claim 1 wherein the mixing rates of animal blood and food byproduct are at from 10:90 to 90:10 and preferred rates at from 20:80 to 50:50 on solid basis.

5. The method of claim 1 wherein heat is applied at any stage during the process.

6. The method of claim 1 wherein moisture of the food byproduct or the mixture of the food byproduct and animal blood after the heating to above 65° C. for coagulation is reduced by screening, filtration, pressing, heating, setting, centrifuging or their combination processes.

7. The method of claim 6 wherein the pressing process is done through a screen with holes or cloth and screen together in a presser to remove moisture mechanically.

8. The method of claim 1 wherein the non-oily and non-sticky product is wet or dry.

9. The method of claim 1 wherein the non-oily and non-sticky dry product is used for food and feed applications.

10. The method of claim 1 wherein the non-oily and non-sticky dry product has bypass function for ruminants.

11. A method of preparing a non-oily and non-sticky dry product comprising mixing liquid animal blood with a food byproduct or feed ingredient at from 5:95 to 50:50 with preferred range at from 10:90 to 30:70 on solid basis and heating to above 65° C. for coagulation to form a wet product, increasing solid level to more than 35% on weight basis, and using a drying equipment to dry the wet product into the non-oily and non-sticky dry product.

12. The method of claim 11 wherein the food byproduct or feed ingredient with oily, sticky, non-oily or non-sticky property.

13. The method of claim 11 wherein the liquid animal blood is from whole animal blood or after removing plasma.

14. The method of claim 11 wherein the food byproduct or feed ingredient is in wet or dry form.

15. The method of claim 11 wherein heat is applied at any stage during the process.

16. The method of claim 11 wherein the non-oily and non-sticky product is wet or dry.

17. The method of claim 11 wherein the non-oily and non-sticky dry product is used for food and feed applications.

18. The method of claim 11 wherein the non-oily and non-sticky dry product has bypass function for ruminants.
